(19) United States
(12) Patent Application Publication
(10) Pub. No.: US 2004/0123722 A1
(43) Pub. Date: Jul. 1, 2004

(54) Musical coaster

(76) Inventor: Wayne Cohen, Bangkok (TH)

Correspondence Address: BAKER & BOTTS, 30 ROCKEFELLER PLAZA, NEW YORK, NY, 10112

(21) Appl. No.: 10/688,367

(22) Filed: Oct. 17, 2003

Related U.S. Application Data
(60) Provisional application No. 60/419,601, filed on Oct. 18, 2002.

(51) Int. Cl. G10D 13/08

(52) U.S. Cl. 84/410

(57) ABSTRACT

A coaster has a plastic bottom member having an upwardly extending peripheral rim, and a bottom wall with in the rim. A plastic top member has a downwardly extending peripheral rim and a top wall within the rim. The peripheral rim of the top member is sized and arranged to be received within the peripheral rim of the bottom member forming a hollow closed chamber between the upper surface and the lower surface, which preferably contains sounding pellets. An array of protrusions may be formed on one of the top surface and the bottom surface.

This application claims the benefit of Provisional Patent Application Serial No. 60/419,601, filed Oct. 18, 2002.

### BACKGROUND OF THE PRESENT INVENTION

This invention relates to a coaster which also functions as a musical instrument. It is anticipated that the invention will be used in nightclub or other establishment which serves beverages and also provides musical entertainment.

### SUMMARY OF THE INVENTION

In accordance with the invention there is provided a coaster having a plastic bottom member having an upwardly extending peripheral rim, and a bottom wall within the rim. The bottom wall has a bottom surface and an upper surface. There is further provided a plastic top member having a downwardly extending peripheral rim and a top wall within the rim. The top wall has a top surface and a lower surface. The peripheral rim of the top member is sized and arranged to be received within the peripheral rim of the bottom member forming a hollow closed chamber between the upper surface and the lower surface. An irregular surface texture is formed on one of the top surface and the bottom surface.

The surface texture may be ridges or dimples. The peripheral rim of the bottom member may extend upwardly by a distance that is greater than a distance by which the peripheral rim of the top member extends downwardly, so that when the top member is received in the bottom member, the bottom member peripheral rim extends above the top surface. The bottom member or top member may further includes a dividing ridge extending between the top and bottom walls, the dividing ridge separating the closed chamber into two chambers. Sounding pellets may be provided in the chambers. A recess may be provided for receiving a scraper. The recess may be at least partially bounded by a dividing ridge. The irregular surface texture may be formed on the top and bottom surfaces and the top surface may include a smooth central region. At least three legs may be provided spaced around the periphery of the bottom surface. A radially interior surface of the peripheral rim on the bottom member may be a conical surface which is wider at the top of the rim than at the bottom wall, and a radially exterior surface of the peripheral rim of the top member may be a conical surface which is wider at the top wall than at the bottom of the rim, wherein the radially exterior conical surface is sized to mate with the radially interior conical surface. The bottom member may include at least one groove formed as a circular segment within the peripheral rim, and wherein the peripheral rim of the top member is arranged to fit into the groove. The groove on the bottom member can be formed by an inner ridge forming a circular segment. The top member may include a groove for receiving the inner ridge. The bottom member may include two semi-circular grooves, formed by oppositely facing D-shaped inner ridges, the ridges being spaced apart from each other along a straight portion thereof. A recess for receiving a scraper can be arranged between the spaced apart straight portions of the D-shaped inner ridges. The peripheral rim on the top member may extend in an upward direction forming a rim around the top surface. The top member can be made of smooth and transparent material. The bottom member and the top member may be circular.

In accordance with the invention there is provided a coaster which includes a plastic bottom member having an upwardly extending peripheral rim, and a bottom wall within the rim, the bottom wall having a bottom surface having an irregular surface texture and an upper surface. A pair of oppositely facing D-shaped ridges are formed on the upper surface of the bottom wall, the D-shaped ridges forming a peripheral groove with the peripheral rim, and forming a recess for receiving a scraper between spaced apart straight portions of the D-shaped ridges. A plastic top member is provided having a downwardly extending peripheral rim, having a size to be received in the peripheral groove of the bottom member, and a top wall within the rim, the top wall closing the space within the D-shaped ridges to form two closed chambers which include sounding pellets.

The top wall may be formed of transparent plastic, so that a printed insert can be placed under the top wall. The peripheral rim on the top member extends in an upward direction forming a rim around the top surface.

In accord with the invention there is provided a coaster having a plastic bottom member having an upwardly extending peripheral rim, and a bottom wall within the rim. The bottom wall has a bottom surface having an irregular surface texture and an upper surface. A pair of oppositely facing D-shaped ridges are formed on the upper surface of the bottom wall. The D-shaped ridges form a peripheral groove with the peripheral rim, and form a recess for receiving a scraper between spaced apart straight portions of the D-shaped ridges. A plastic top member is provided having a downwardly extending peripheral rim having a size to be received in the peripheral groove of the bottom member. The top member has a top wall within the rim, the top wall closing the space within the D-shaped ridges to form two closed chambers. The top member having two downwardly extending D-shaped ridges within the peripheral rim, the D-shaped ridges of the top member are sized to be received within the D-shaped ridges of the bottom member. Sounding pellets are provided within the closed chambers.

The top member may further include two downwardly extending straight ridges between the D-shaped ridges of the top member. The straight ridges can be arranged to fit between the straight portions of the D-shaped ridges on the bottom member on opposite sides of the recess. The bottom member may further include two upwardly extending straight ridges between the straight portions of the D-shaped ridges of the bottom member, the straight ridges being arranged to fit between the straight ridges of the top member on opposite sides of the recess. The top member may further include a central downwardly facing straight ridge arranged to cover the recess and define a top boundary thereof.

In accordance with the invention there is provided a coaster comprising a plastic member having an upwardly extending rim and a bottom wall within the rim. The bottom wall has a top surface and a bottom surface and an irregular surface on one of the surfaces for forming a guiro.

The coaster may further include at least three downwardly extending legs spaced around the periphery of the bottom wall.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 is a perspective top view of one embodiment of a coaster in accordance with the invention.

FIG. 2 is a perspective bottom view of the FIG. 1 coaster.

FIG. 3 is a cross-sectional view of the FIG. 1 coaster.

FIG. 4 is side elevation view of the FIG. 1 coaster.

FIG. 5 is another side elevation view the FIG. 1 coaster.

FIG. 6 is a top plan view of the FIG. 1 coaster.

FIG. 7 is a bottom plan view of the FIG. 1 coaster.

FIG. 8 is a side view of a scraper for use with the FIG. 1 coaster.

FIG. 9 is a top plan view of the FIG. 1 coaster with the top member removed.

FIG. 10 is a side view of an alternate embodiment of the invention.

FIG. 11 is a side view of another alternate embodiment of the invention.

FIG. 12 is a bottom plan view of the embodiment of FIG. 11.

FIG. 13 is a top plan view of the coaster of FIG. 10 with the top member removed.

FIG. 14 is a cross-sectional view of another alternate embodiment of the invention.

FIG. 15 is an exploaded view of another embodiment of the invention.

FIG. 16 is a top view of the assembled FIG. 15 coaster.

FIG. 17 is a perspective view of the assembled FIG. 15 coaster.

FIG. 18 is a top view of the bottom member of the FIG. 15 coaster.

FIG. 19 is a side view of the FIG. 18 bottom member.

FIG. 20 is cross-sectional view of the FIG. 18 bottom member.

FIG. 20A is a detailed view of the FIG. 20 cross section.

FIG. 21 is a bottom view of the FIG. 18 bottom member.

FIG. 22 is another cross-sectional view of the FIG. 18 bottom member.

FIG. 23 shows a scraper for use with the FIG. 15 coaster.

FIG. 24 is a central cross-sectional view of the FIG. 15 coaster taken along the scraper positioned therein.

FIG. 25 is a central cross-sectional view of the FIG. 15 coaster taken perpendicular to The FIG. 24 cross-section.

FIG. 25A is a detail of the cross-section of FIG. 25.

FIG. 26 is a top view of a top member of the coaster of FIG. 15.

FIG. 27 is a side view of the top member of FIG. 26.

FIG. 28 is a cross-sectional view of the top member of FIG. 26.

FIG. 29 is a bottom view of the top member of FIG. 26.

FIG. 30 is a cross-sectional view of the top member of FIG. 26.

FIG. 30A is a detail of the cross-section of FIG. 30.

FIG. 31 is a bottom view of a coaster having dimple protrusions on the bottom surface.

FIG. 32 shows perspective views of a transparent top member and a printed insert for use therewith.

### DESCRIPTION OF THE INVENTION

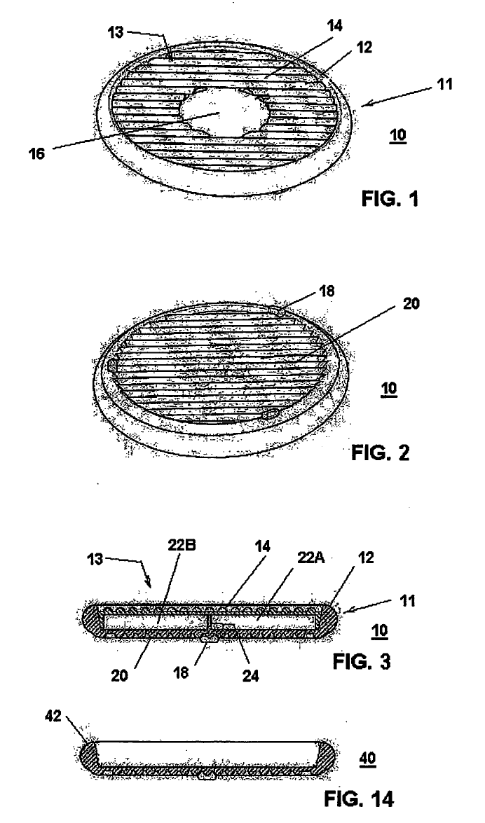

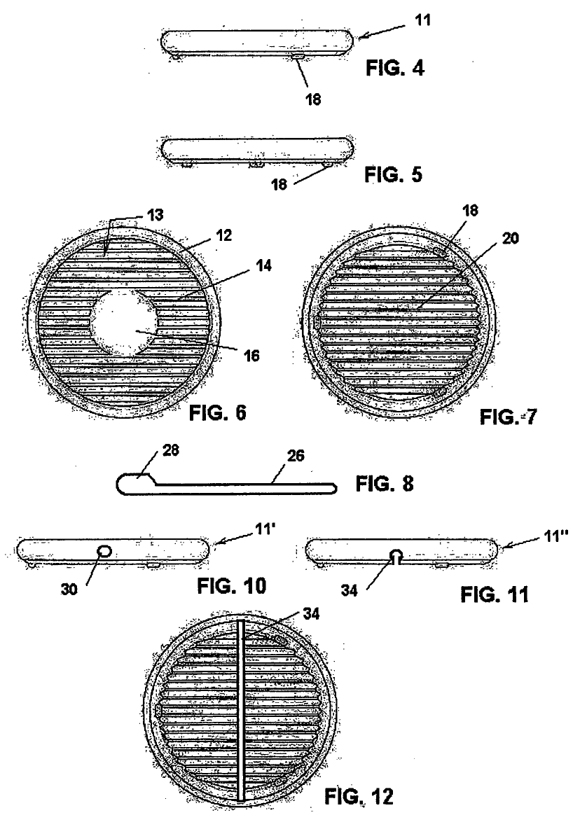

Referring to FIGS. 1-7 and 9 there is depicted a first embodiment of the invention. The embodiment is a circular coaster 10 which is formed with a bottom member 11 and top member 13. The members may be fabricated of plastic, such as HIPS or K-Resin, for example by injection molding. The two members may be bonded together using adhesive, or joined by ultrasonic welding.

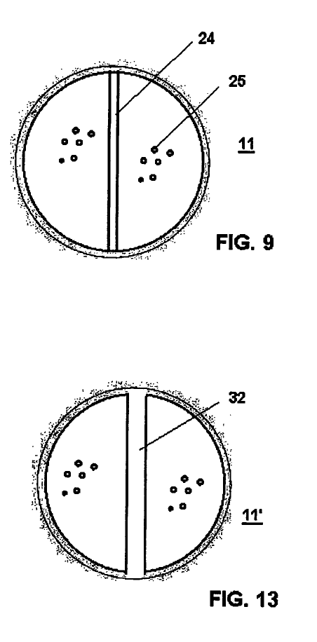

As shown in the cross-sectional view of FIG. 3, in one arrangement the bottom member 10 includes a central divider ridge 24 which divides the interior of the coaster into two hollow chambers 22A and 22B on opposite sides of divider 24. FIG. 9 is a top view of the bottom member 11 with the top member 13 removed. Within the chambers 22A and 22B of the bottom member 11 there may be placed steel shot 25 or other sound producing pellets.

At the top of coaster 10 there may be formed a peripheral ring 12 which is arranged to limit movement of a glass resting on the coaster. Optionally the top surface may include ridges 14 between which condensation from a cold beverage glass will be accomodated. Preferably the ridges 14 are not provided in a central region 16 which is rendered flat to receive the identification of the establishment, such as a nightclub, or alternatively an advertisement of a beverage or other item or service.

Referring to FIG. 2 the bottom member 11 may have three or more legs 18 on it's lower surface on which the coaster will rest when placed on a table or bar. The lower exterior surface of member 11 may include an irregular surface texture in the form of ridges 20 which are intended to be used as guiro for purposes of amusement.

FIG. 8 is a side view of a scraper 26 having an enlarged end 28 to be held by the user for playing the guiro of the first embodiment of the invention.

The interior of the coaster 10 is preferably divided into two chamber 22A and 22B by a divider ridge on the top or bottom member and steel shot 25 is provided in the interior space to enable it to function as a shaker. By providing divider ridge 24 to divide the interior into two semi-circular cavities, a better performance of the device as a shaker can be realized, since the travel of the shot from one end of the cavity to the other is a shorter duration for the smaller semi-circular cavity, consistent with the rythm of most music, as compared to a cavity which is the entire interior of the coaster.

In the first embodiment, the coaster acts as both a guiro and a shaker instrument and includes the ridges 14, 20 on the top or bottom surface, or both, for providing a guiro sound and the shot 25 within the chambers 22A and 22B for providing a shaker sound. In a second embodiment, the shot 25 may not be provided, and the coaster may be usable as a guiro only. In a third embodiment the ridges 20 on the bottom of lower member 11 may be eliminated and the device will function as a shaker only.

FIG. 10 shows an alternate embodiment 11′ of the invention having a bore 30 passing through the lower member and accommodated in a wider divider 32 which is shown in FIG. 13. Bore 30 is intended to receive scraper 26 in a packaged device or after use by the customer.

FIG. 11 shows a further alternate embodiment 11′ which includes a groove 34 for receiving scraper 26. The groove 34 likewise passes through a wide central divider 32 as shown in FIG. 13 and provides a slot 34 across the lower surface of lower member 11″, as shown in FIG. 12.

FIG. 14 shows still another version wherein coaster 40 is of single piece construction and includes a bottom wall and a peripheral ridge 42, as well as grooves on the bottom or upper surface of the bottom wall. The coaster 40 of FIG. 14 does not include a hollow chamber, but a sounding chamber can be provided by the user holding the coaster in a cupped hand.

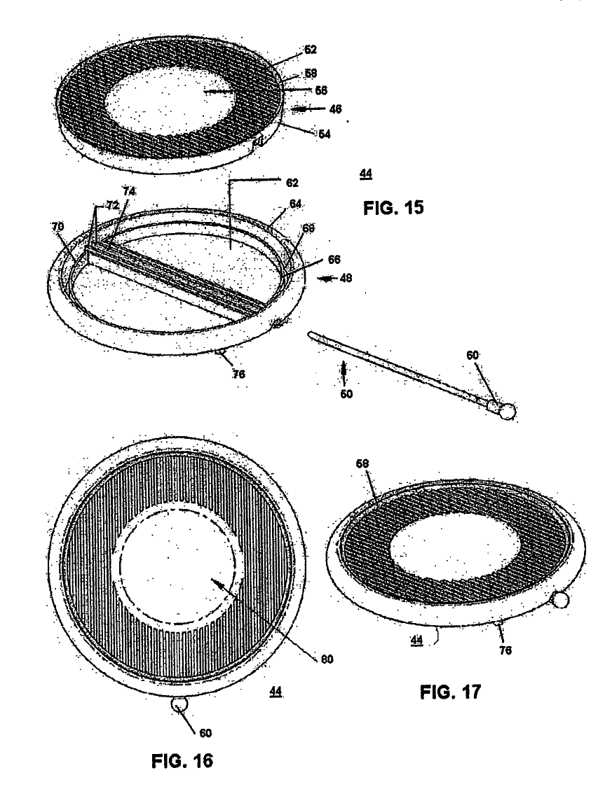

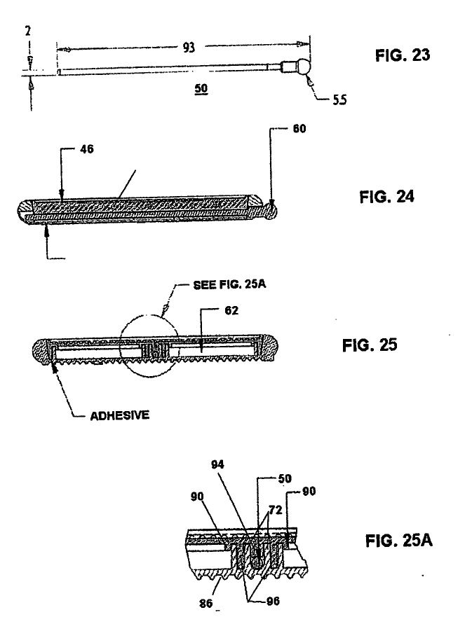

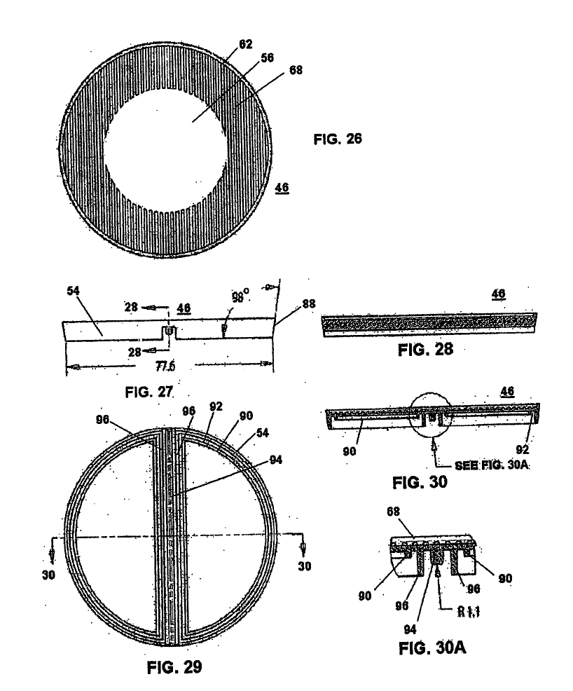

FIGS. 15 through 30 show a further embodiment of the invention. FIG. 15 is an exploaded view of a coaster in accordance with the invention having improved resistance to moisture. It has been found to be advantageous to take measures in the construction of the coaster of the invention to prevent water or moisture from entering the cavities containing pellets, such as steel shot. Moisture, for example from condensation or washing, can cause the shot to rust, and without a good seal, will result in rusty water seeping from the chambers containing the steel shot.

The coaster of FIG. 15 includes a top member 46, a bottom member 48 and a scraper 50, formed as a plastic stick with an enlarged end 60. Top member 46 and bottom member 48 are preferably injection molded out of plastic material such as HIPS or K-RASIN, and are shaped to be capable of fabrication in a two-cavity injection mold. Top member 46 is in the form of a disc having a wall forming the top surface of the coaster and having a lower, interior surface. A peripheral rim 54 surrounds the top wall and extends downwardly therefrom. Optionally peripheral rim 54 has an upward extension 58 which forms a boundary of the top surface. The top surface may have an irregular surface texture in the form of dimples or ridges 52 and optionally a central area 56 which is flat to receive a logo for an establishment or an advertisement for a product or service.

Bottom member 48 includes a bottom wall 62 having an interior upper surface and a bottom surface. A peripheral rim 64 surrounds the bottom wall and receives the perepheral rim 64 of the top member. Within the cavity formed by the bottom wall 62 and peripheral rim 64, two D-shaped ridges 66, 70 extend upwardly and form two cavities for receiving sounding pellets. A circular segment groove 68 is formed between D-shaped ridges 66, 70 and peripheral rim 64, which groove is sized and arranged to receive rim 54 of top member 46. In the embodiment illustrated two semi-circular grooves are provided. Groove 68 may alternately be a full circlular segment or any partial circular segment. Straight divider ridges 72 are arranged between the straight portions of D-shaped ridges 66, 70 and form a central recess 74 for receiving scraper 50 through an opening 84 (see FIG. 20A) in rim 64. Bottom member 48 is optionally provided with at least three short legs 76 spaced around the periphery of the bottom surface for resting on a table or bar.

It will be recognized that the shape of the coaster may be other than circular and that the internal ridges may have a different form to accomodate the overall shape of the coaster.

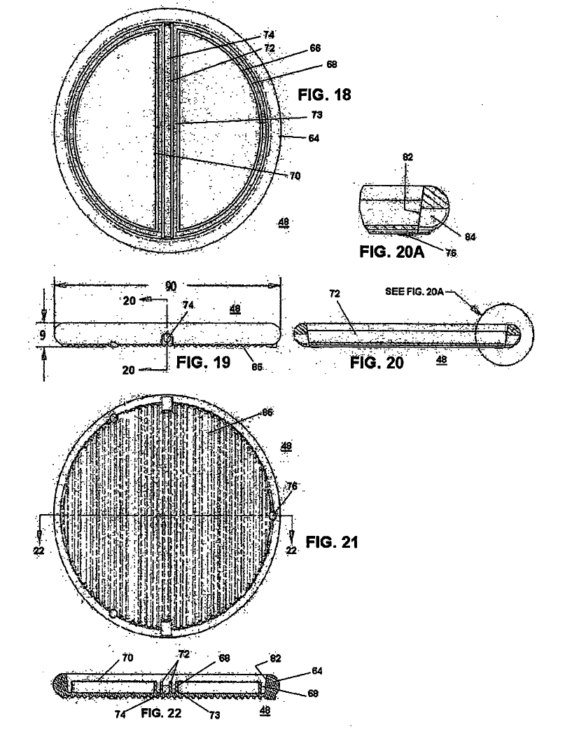

FIGS. 18 to 22 show further details of bottom member 48, including the fact that the radially interior wall 82 of rim 64 is conical, and an opening 84 is provided at the end of recess 74 for receiving the scraper 50.

Details of the top member 46 are shown in FIGS. 26 to 30. The radially exterior wall 88 of rim 54 is also conical to fit into the conical interior of rim 64 of bottom member 48. The lower side of top member 46 includes straight divider ridges 96, and a central ridge 94 of lesser extension. As shown in the assembled cross-sectional view of FIG. 25 and FIG. 25A, straight ridges 96 of top member 46 are arranged to be received between the straight portions of D-shaped ridges 66,70 and divider ridges 72 of bottom member 48. Central ridge 94 forms an upper boundary for recess 74 to guide scraper 50. Top member 46 also includes D-shaped ridges 90 of lesser extension for forming a peripheral groove 92 which receives the D-shaped ridges of bottom member 48. The interlocking ridges, with the use of adhesive, form a watertight seal of the pellet chambers within the coaster, both at the periphery and in the region of the recess 74 for holding the scraper 50.

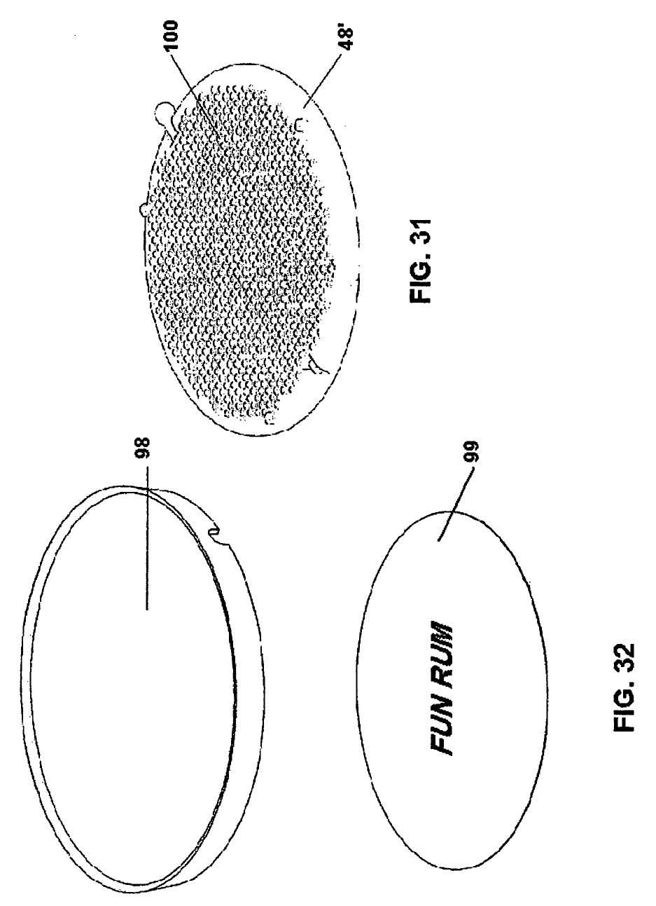

FIG. 31 is a bottom view of an alternate embodiment of a bottom member 48′, wherein the bottom surface is provided with dimples.

FIG. 32 shows an alternate of the top member wherein top member 98 has a flat wall, which is fabricated of clear plastic, to enable viewing of a label or advertisement printed insert 99.

While there have been described what are believed to be the preferred embodiments of the invention, those skilled in the art will recognize that other and further changes and modifications may be made thereto without departing from the spirit of the invention, and it is intended to claim all such changes and modifications as fall within the true scope of the invention.

I claim:

1. A coaster, comprising:
a plastic bottom member having an upwardly extending peripheral rim, and a bottom wall within said rim, said bottom wall having a bottom surface and an upper surface;
a plastic top member having a downwardly extending peripheral rim and a top wall within said rim, said top wall having a top surface and a lower surface, said peripheral rim of said top member being sized and arranged to be received within said peripheral rim of said bottom member forming a hollow closed chamber between said upper surface and said lower surface, and
an irregular surface texture formed on one of said top surface and said bottom surface.

2. A coaster as specified in claim 1 wherein said irregular surface texture comprises ridges.

3. A coaster as specified in claim 1 wherein said irregular surface texture comprises dimples.

4. A coaster as specified in claim 1 wherein said peripheral rim of said bottom member extends upwardly by a distance that is greater than a distance by which said peripheral rim of said top member extends downwardly, so that when said top member is received in said rim of said bottom member said bottom member peripheral rim extends above said top surface.

5. A coaster as specified in claim 1 wherein one of said bottom member and said top member further includes a dividing ridge extending between said top and bottom walls, said dividing ridge separating said closed chamber into two chambers.

6. A coaster as specified in claim 5 wherein sounding pellets are provided in said chambers.

7. A coaster as specified in claim 1 wherein sounding pellets are provided in said chamber.

8. A coaster as specified in claim 1 further including a recess for receiving a scraper.

9. A coaster as specified in claim 8 wherein said bottom member further includes a dividing ridge extending upwardly from said upper surface, said dividing ridge separating said closed chamber into two chambers, and wherein said recess is at least partially bounded by said dividing ridge.

10. A coaster as specified in claim 1 wherein said irregular surface texture is formed on said top and bottom surfaces and wherein said top surface has a central region free of irregularities.

11. A coaster as specified in claim 1 wherein there are provided at least three legs spaced around the periphery of the bottom surface.

12. A coaster as specified in claim 1 wherein a radially interior surface of said peripheral rim on said bottom member is a conical surface which is wider at the top of said rim than at said bottom wall, and wherein a radially exterior surface of said peripheral rim of said top member is a conical surface which is wider at said top wall than at the bottom of said rim, said radially exterior conical surface being sized to mate with said radially interior conical surface.

13. A coaster as specified in claim 1 wherein said bottom member includes at least one groove formed as a circular segment within said peripheral rim, and wherein said peripheral rim of said top member is arranged to fit into said groove.

14. A coaster as specified in claim 13 wherein said at least one groove on said bottom member is formed by an inner ridge forming a circular segment, and wherein said top member includes a groove for receiving said inner ridge.

15. A coaster as specified in claim 13 wherein said bottom member includes two semi-circular grooves.

16. A coaster as specified in claim 15 wherein said semi-circular grooves are formed by oppositely facing D-shaped inner ridges, said ridges being spaced apart from each other along a straight portion thereof.

17. A coaster as specified in claim 16 wherein a recess for receiving a scraper is arranged between said spaced apart straight portions of said D-shaped inner ridges.

18. A coaster as specified in claim 1 wherein said peripheral rim on said top member extends in an upward direction forming a rim around said top surface.

19. A coaster as specified in claim 1 wherein said top member is smooth and made of transparent material.

20. A coaster as specified in claim 1 wherein said bottom member and said top member are circular.

21. A coaster comprising:
a plastic bottom member having an upwardly extending peripheral rim, and a bottom wall within said rim, said bottom wall having a bottom surface having protrusions and an upper surface;
a pair of oppositely facing D-shaped ridges on said upper surface of said bottom wall, said D-shaped ridges forming a peripheral groove with said peripheral rim, and forming a recess for receiving a scraper between spaced apart straight portions of said D-shaped ridges;
a plastic top member having a downwardly extending peripheral rim, having a size to be received in said peripheral groove of said bottom member, and a top wall within said rim, said top wall closing the space within said D-shaped ridges to form two closed chambers; and
sounding pellets within said closed chambers.

22. A coaster as specified in claim 21 wherein said top wall is formed of transparent plastic.

23. A coaster as specified in claim 22 further including a printed insert under said top wall.

24. A coaster as specified in claim 21 wherein said peripheral rim on said top member extends in an upward direction forming a rim around said top surface.

25. A coaster comprising:
a plastic bottom member having an upwardly extending peripheral rim, and a bottom wall within said rim, said bottom wall having a bottom surface having protrusions and an upper surface;
a pair of oppositely facing D-shaped ridges on said upper surface of said bottom wall, said D-shaped ridges forming a peripheral groove with said peripheral rim, and forming a recess for receiving a scraper between spaced apart straight portions of said D-shaped ridges;
a plastic top member having a downwardly extending peripheral rim, having a size to be received in said peripheral groove of said bottom member, said top member having a top wall within said rim, said top wall closing the space within said D-shaped ridges to form two closed chambers, and said top member having two downwardly extending D-shaped ridges within said peripheral rim, said D-shaped ridges of said top member being sized to be received within said D-shaped ridges of said bottom member; and
sounding pellets within said closed chambers.

26. A coaster as specified in claim 25 wherein said top member further includes two downwardly extending straight ridges between said D-shaped ridges of said top member, said straight ridges being arranged to fit between said straight portions of said D-shaped ridges on said bottom member on opposite sides of said recess.

27. A coaster as specified in claim 26 wherein said bottom member further includes two upwardly extending straight ridges between said straight portions of said D-shaped ridges of said bottom member, said straight ridges being arranged to fit between said straight ridges of said top member on opposite sides of said recess.

28. A coaster as specified in claim 27 wherein said top member further includes a central downwardly facing straight ridge arranged to cover said recess and define a top boundary thereof.

29. A coaster comprising a plastic member having an upwardly extending rim and a bottom wall within said rim, said bottom wall having a top surface and a bottom surface and an irregular surface on one of said surfaces for forming a guiro.

30. A coaster as specified in claim 29 wherein said coaster further includes at least three downwardly extending legs spaced around the periphery of said bottom wall.

31. A coaster, comprising:
a plastic bottom member having an upwardly extending peripheral rim, and a bottom wall within said rim, said bottom wall having a bottom surface and an upper surface;
a plastic top member having a downwardly extending peripheral rim and a top wall within said rim, said top wall having a top surface and a lower surface, said peripheral rim of said top member being sized and arranged to be received within said peripheral rim of said bottom member forming a hollow closed chamber between said upper surface and said lower surface, and
sounding pellets in said closed chamber.

32. A coaster as specified in claim 31 wherein one of said bottom member and said top member further includes a dividing ridge extending between said top and bottom walls, said dividing ridge separating said closed chamber into two chambers.

33. A coaster as specified in claim 31 wherein a radially interior surface of said peripheral rim on said bottom member is a conical surface which is wider at the top of said rim than at said bottom wall, and wherein a radially exterior surface of said peripheral rim of said top member is a conical surface which is wider at said top wall than at the bottom of said rim, said radially exterior conical surface being sized to mate with said radially interior conical surface.

34. A coaster as specified in claim 31 wherein said bottom member includes at least one groove formed as a circular segment within said peripheral rim, and wherein said peripheral rim of said top member is arranged to fit into said groove.

35. A coaster as specified in claim 34 wherein said at least one groove on said bottom member is formed by an inner ridge forming a circular segment, and wherein said top member includes a groove for receiving said inner ridge.
